(19) United States
(12) Patent Application Publication
(10) Pub. No.: US 2023/0232103 A1
(43) Pub. Date: Jul. 20, 2023

(54) IMAGE PROCESSING DEVICE, IMAGE DISPLAY SYSTEM, METHOD, AND PROGRAM

(71) Applicant: SONY GROUP CORPORATION, TOKYO (JP)

(72) Inventor: DAITA KOBAYASHI, TOKYO (JP)

(21) Appl. No.: 18/002,034

(22) PCT Filed: Jun. 9, 2021
(86) PCT No.: PCT/JP2021/021875

§ 371 Date: Dec. 15, 2022

(30) Foreign Application Priority Data
Jun. 23, 2020 (JP) 2020-107901

(51) Int. Cl. H04N 23/68; H04N 5/262; H04N 23/741; H04N 23/80; G06F 3/01; G02B 27/01

(52) U.S. Cl. CPC H04N 23/683; H04N 5/2628; H04N 23/741; H04N 23/80; G06F 3/013; G02B 27/0179; G02B 27/0172; G02B 2027/0187; G02B 2027/0138; G02B 2027/014

(57) ABSTRACT

An image processing device of an embodiment includes a control unit that generates a composite image and outputs the composite image to a display device, the composite image being acquired by combination of a first image captured in first exposure time and having first resolution, and a second image that is an image corresponding to a part of a region of the first image, and that is captured in second exposure time shorter than the first exposure time and has second resolution higher than the first resolution, the first image and the second image being input from an image sensor.

### FIELD

The present disclosure relates to an image processing device, an image display system, a method, and a program.

### BACKGROUND

Conventionally, on the assumption of being mainly used in a video see-through (VST) system, a technology of being capable of reducing a processing load on image processing by calculating a region of interest from an eye gaze position estimated by an eye tracking system, and performing processing of thinning out an image only in a non-region of interest (resolution conversion processing) after photographing has been proposed (see, for example, Patent Literature 1).

### CITATION LIST

### Patent Literature

Patent Literature 1: Japanese Patent Application Laid-open No. 2019-029952

Patent Literature 2: Japanese Patent Application Laid-open No. 2018-186577

Patent Literature 3: Japanese Patent No. 4334950

Patent Literature 4: Japanese Patent Application Laid-open No. 2000-032318

Patent Literature 5: Japanese Patent No. 5511205

### SUMMARY

### Technical Problem

In the conventional technology described above, resolution conversion processing is performed only on a portion other than a region of interest acquired by an eye tracking system and resolution thereof is reduced, whereby a load of image processing in an image signal processor (ISP) is prevented from being increased more than necessary.

Thus, in the above-described conventional method, there is a problem that a blur reduction effect cannot be acquired and a high dynamic range (HDR) effect cannot be acquired since exposure conditions of a region of interest and a non-region of interest are constantly the same.

The present technology has been made in view of such a situation, and is to provide an image processing device, an image display system, a method, and a program capable of acquiring a blur reduction effect and an HDR effect while reducing a processing load on image processing.

### Solution to Problem

An image processing device of an embodiment includes: a control unit that generates a composite image and outputs the composite image to a display device, the composite image being acquired by combination of a first image captured in first exposure time and having first resolution, and a second image that is an image corresponding to a part of a region of the first image, and that is captured in second exposure time shorter than the first exposure time and has second resolution higher than the first resolution, the first image and the second image being input from an image sensor.

### BRIEF DESCRIPTION OF DRAWINGS

FIG. 1 is a schematic configuration block diagram of a head mounted display system of an embodiment.

FIG. 2 is a view for describing a VR head mounted display system, and illustrating an arrangement state of cameras.

FIG. 3 is a view for describing an example of an image display operation of the embodiment.

FIG. 4 is a view for describing variable foveated rendering.

FIG. 5 is a view for describing fixed foveated rendering.

FIG. 6 is a view for describing motion compensation using an optical flow.

FIG. 7 is a view for describing motion compensation using a self-position.

FIG. 8 is a view for describing image composition.

FIG. 9 is a view for describing photographing order of a low-resolution image and high-resolution images in the above embodiment.

FIG. 10 is a view for describing another photographing order of a low-resolution image and high-resolution images.

FIG. 11 is a view for describing another photographing order of a low-resolution image and high-resolution images.

### DESCRIPTION OF EMBODIMENTS

Next, an embodiment will be described in detail with reference to the drawings.

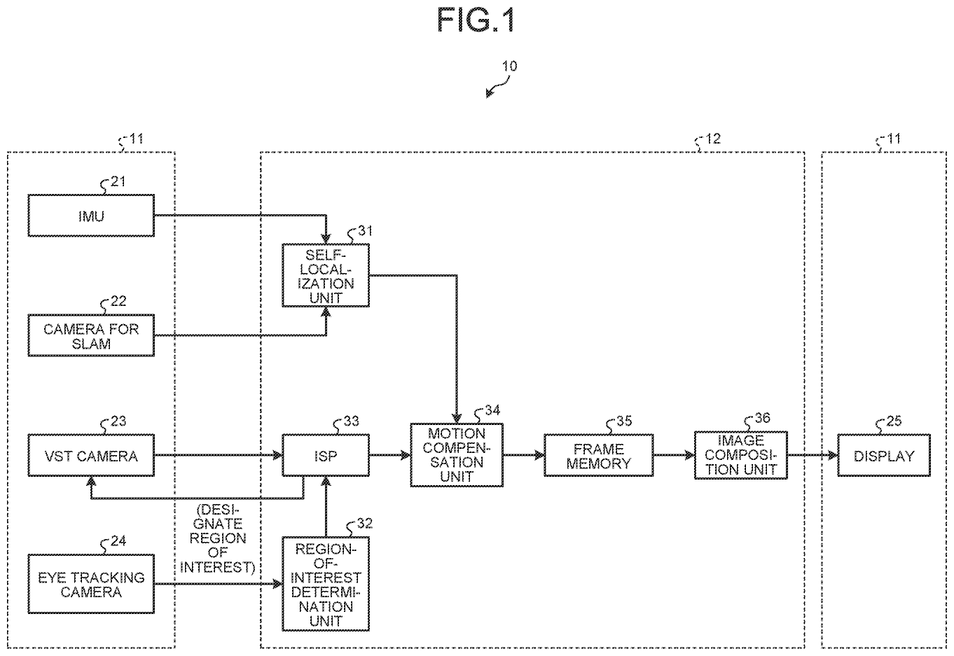

FIG. 1 is a schematic configuration block diagram of a VR head mounted display system of the embodiment.

A personal computer connected-type VR head mounted display system is exemplified in FIG. 1.

The VR head mounted display system 10 roughly includes a head mounted display (hereinafter, referred to as HMD unit) 11 and an information processing device (hereinafter, referred to as PC unit) 12.

Here, the PC unit 12 functions as a control unit that controls the HMD unit 11.

The HMD unit 11 includes an inertial measurement unit (IMU) 21, a camera for simultaneous localization and mapping (SLAM) 22, a video see-through (VST) camera 23, an eye tracking camera 24, and a display 25.

The IMU 21 is a so-called motion sensor, senses a state or the like of a user, and outputs a sensing result to the PC unit 12.

The IMU 21 includes, for example, a three-axis gyroscope sensor and a three-axis acceleration sensor, and outputs motion information of a user (sensor information) corresponding to detected three-dimensional angular velocity, acceleration, and the like to the PC unit 12.

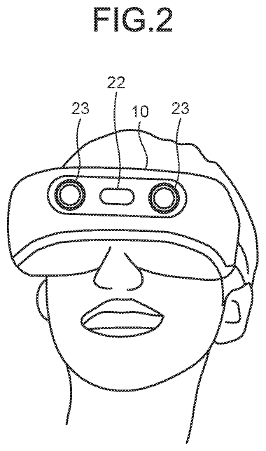

FIG. 2 is a view for describing the VR head mounted display system, and illustrating an arrangement state of cameras.

The camera for SLAM 22 is a camera that simultaneously performs self-localization and environmental mapping called SLAM, and acquires an image to be used in a technology of acquiring a self-position from a state in which there is no prior information such as map information. The camera for SLAM is arranged, for example, at a central portion of a front surface of the HMD unit 11, and collects information to simultaneously perform self-localization and environmental mapping on the basis of a change in an image in front of the HMD unit 11. The SLAM will be described in detail later.

The VST camera 23 acquires a VST image, which is an external image, and performs an output thereof to the PC unit 12.

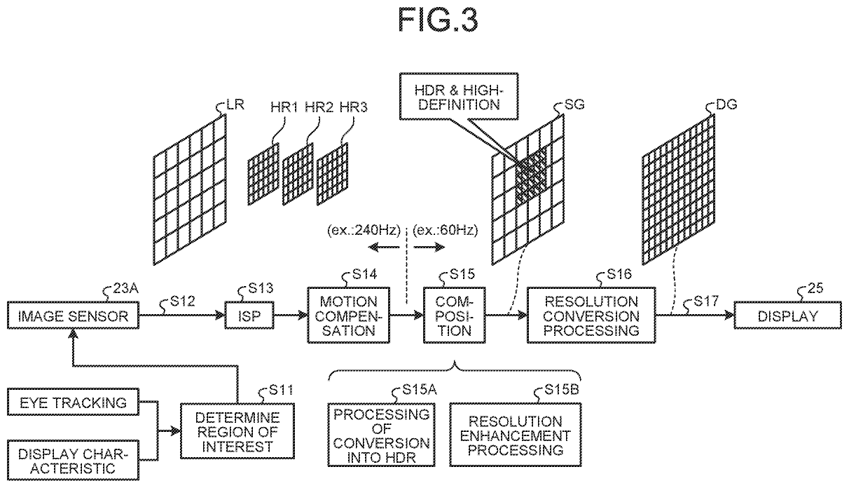

The VST camera 23 includes a lens installed for VST outside the HMD unit 11 and an image sensor 23A (see FIG. 3). As illustrated in FIG. 2, a pair of the VST cameras 23 is provided in such a manner as to correspond to positions of both eyes of the user.

In this case, imaging conditions (such as resolution, imaging region, and imaging timing) of the VST cameras 23 and thus the image sensors are controlled by the PC unit 12.

Each of the image sensors 23A (see FIG. 3) included in the VST cameras 23 of the present embodiment has, as operation modes, a full resolution mode having high resolution but a high processing load, and a pixel addition mode having low resolution but a low processing load.

Then, the image sensor 23A can perform switching between the full resolution mode and the pixel addition mode in units of frames under the control of the PC unit 12.

In this case, the pixel addition mode is one of drive modes of the image sensors 23A, and exposure time is longer and an image having less noise can be acquired as compared with the full resolution mode.

Specifically, in a 2×2 addition mode as an example of the pixel addition mode, 2×2 pixels in vertical and horizontal directions (four pixels in total) are averaged and output as one pixel, whereby an image with resolution being ¼ and a noise amount being about ½ is output. Similarly, in a 4×4 addition mode, since 4×4 pixels in the vertical and horizontal directions (16 pixels in total) are averaged and output as one pixel, an image with resolution being 1/16 and a noise amount being about ¼ is output.

The eye tracking camera 24 is a camera to perform tracking of an eye gaze of the user, which is so-called eye tracking. The eye tracking camera 24 is configured as an external visible light camera or the like.

The eye tracking camera 24 is used to detect a region of interest of the user by using a method such as variable foveated rendering. According to the recent eye tracking camera 24, an eye gaze direction can be acquired with accuracy of about ±0.5°.

The display 25 is a display device that displays an image processed by the PC unit 12.

The PC unit 12 includes a self-localization unit 31, a region-of-interest determination unit 32, an image signal processor (ISP) 33, a motion compensation unit 34, a frame memory 35, and an image composition unit 36.

The self-localization unit 31 estimates a self-position including a posture and the like of the user on the basis of the sensor information output by the IMU 21 and an image for SLAM which image is acquired by the camera for SLAM 22.

In the present embodiment, as a method of self-localization by the self-localization unit 31, a method of estimating a three-dimensional position of the HMD unit 11 by using both the sensor information output by the IMU 21 and the image for SLAM which image is acquired by the camera for SLAM 22 is used. However, some methods such as visual odometry (VO) using only a camera image, and visual inertial odometry (VIO) using both a camera image and an output of the IMU 21 can be considered.

The region-of-interest determination unit 32 determines the region of interest of the user on the basis of eye tracking result images of both eyes, which images are the output of the eye tracking camera 24, and outputs the region of interest to the ISP 33.

The ISP 33 designates a region of interest in an imaging region of each of the VST cameras 23 on the basis of the region of interest of the user which region is determined by the region-of-interest determination unit 32.

In addition, the ISP 33 processes an image signal output from each of the VST cameras 23 and performs an output thereof as a processed image signal. Specifically, as the processing of the image signal, “noise removal”, “demosaic”, “white balance”, “exposure adjustment”, “contrast enhancement”, “gamma correction”, or the like is performed. Since a processing load is large, dedicated hardware is basically prepared in many mobile devices.

The motion compensation unit 34 performs motion compensation on the processed image signal on the basis of the position of the HMD unit 11 which position is estimated by the self-localization unit 31, and outputs the processed image signal.

The frame memory 35 stores the processed image signal after the motion compensation in units of frames.

FIG. 3 is a view for describing an example of an image display operation of the embodiment.

Before predetermined imaging start timing, the region-of-interest determination unit 32 determines the region of interest of the user on the basis of at least the eye gaze direction of the user among the eye gaze direction of the user, which direction is based on the eye tracking result images of the both eyes which images are output of the eye tracking camera 24, and characteristics of the display 25, and outputs the region of interest to the VST cameras (Step S11).

More specifically, the region-of-interest determination unit 32 estimates the region of interest by using the eye tracking result images of the both eyes which images are acquired by the eye tracking camera 24.

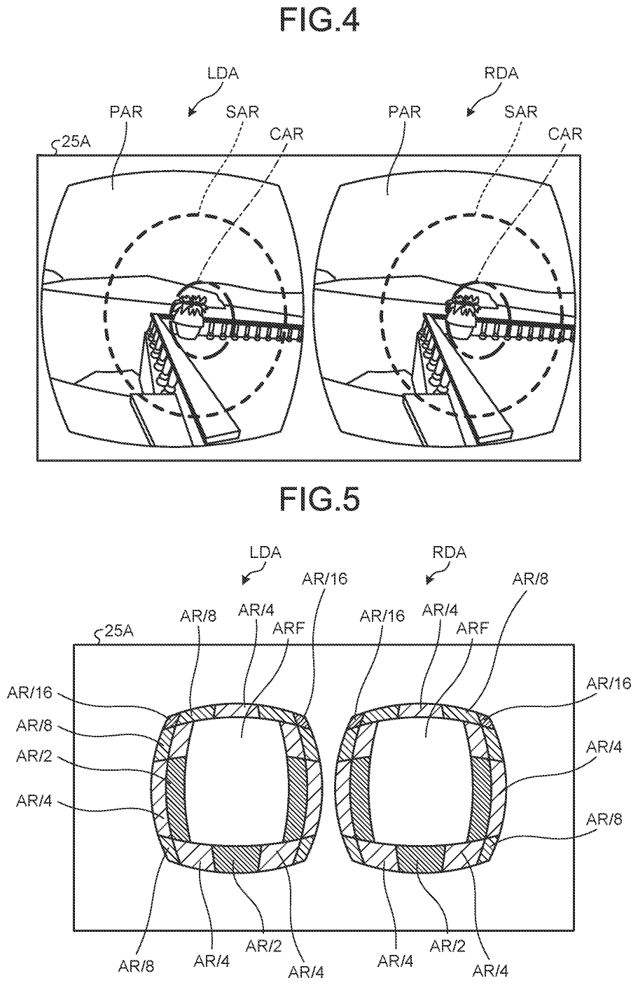

FIG. 4 is a view for describing variable foveated rendering.

As illustrated in FIG. 4, images captured by the VST cameras 23 include a right eye image RDA and a left eye image LDA.

Then, on the basis of the eye gaze direction of the user which direction is based on the eye tracking detection result of the eye tracking camera 24, division into three regions that are a central visual field region CAR centered on the eye gaze direction of the user, an effective visual field region SAR adjacent to the central visual field region CAR, and a peripheral visual field region PAR that is a region away from the eye gaze direction of the user is performed. Then, since the resolution effectively required decreases in order of the central visual field region CAR→the effective visual field region SAR→the peripheral visual field region PAR from the center in the eye gaze direction, at least the entire central visual field region CAR is treated as the region of interest in which the resolution is set to be the highest. Furthermore, drawing is performed with lower resolution toward the outside of the visual field.

FIG. 5 is a view for describing fixed foveated rendering.

In a case where an eye tracking system such as the eye tracking camera 24 cannot be used, the region of interest is determined according to the display characteristics.

In general, since the lens is designed in such a manner that the resolution is the highest at a center of a screen of the display and the resolution decreases toward the periphery, the center of the screen of the display is fixed as the region of interest. Then, as illustrated in FIG. 5, a central region is set as a highest resolution region ARF having full-resolution.

Furthermore, in principle, the resolution in a horizontal direction is set to be higher than that in a vertical direction, and the resolution in a downward direction is set to be higher than that in an upward direction according to a general tendency in likelihood of the eye gaze direction of the user.

That is, as illustrated in FIG. 5, by arrangement a region AR/2 having half the resolution of the highest resolution region ARF, a region AR/4 having ¼ of the resolution of the highest resolution region ARF, a region AR/8 having ⅛ of the resolution of the highest resolution region ARF, and a region AR/16 having 1/16 of the resolution of the highest resolution region ARF, a display according to general characteristics of a visual field of a person who is the user is performed.

As described above, in any method, high resolution drawing (rendering) is limited to a necessary and sufficient region. As a result, since a drawing load in the PC unit 12 can be significantly reduced, it is possible to expect that a hurdle of specifications required for the PC unit 12 is lowered and performance is improved.

Subsequently, each of the VST cameras 23 of the HMD unit 11 starts imaging by the image sensor 23A and outputs a captured image to the ISP 33 (Step S12).

Specifically, each of the VST cameras 23 sets an imaging mode in the image sensor 23A to the pixel addition mode, acquires one piece (corresponding to one frame) of image photographed at the total angle of view and having low resolution and low noise (hereinafter, referred to as low-resolution image LR), and outputs the image to the ISP 33.

Subsequently, each of the VST cameras 23 sets the imaging mode to the full resolution mode, acquires a plurality of high-resolution images in which only a range of an angle of view corresponding to the determined region of interest is photographed (in the example of FIG. 3, three high-resolution images HR1 to HR3), and sequentially outputs the images to the ISP 33.

In this case, for example, in a case where processing time of one frame is 1/60 sec (=60 Hz), a case where processing speed is 1/240 sec (=240 Hz) is taken as an example.

In this case, time of 1/240 sec is allocated to acquire one low-resolution image LR with the imaging mode being set to the pixel addition mode, time of 3/240 sec is allocated to acquire three high-resolution images HR1 to HR3 with the imaging mode being set to the full resolution mode, and processing is performed with 1/60 sec (= 4/240) in total, that is, processing time of one frame.

Subsequently, the ISP 33 performs “noise removal”, “demosaic”, “white balance”, “exposure adjustment”, “contrast enhancement”, “gamma correction”, or the like on the image signals output from the VST cameras 23, and performs an output thereof to the motion compensation unit 34 (Step S13).

The motion compensation unit 34 performs compensation for positional deviation of a subject due to difference in photographing timing of a plurality of (in a case of the above example, four pieces of) images (motion compensation) (Step S14).

In this case, as a reason for generation of the positional deviation, although both of a motion of a head of the user wearing the HMD unit 11 and a motion of the subject are conceivable, here, it is assumed that the motion of the head of the user is dominant (has a greater influence).

For example, two motion compensation methods are conceivable.

The first method is a method using an optical flow, and the second method is a method using a self-position.

Each will be described in the following.

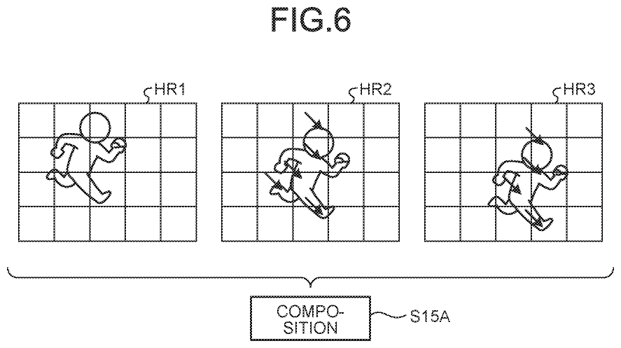

FIG. 6 is a view for describing the motion compensation using the optical flow.

The optical flow is a vector (in the present embodiment, arrow in FIG. 6) expressing a motion of an object (subject including a person) in a moving image. Here, a block matching method, a gradient method, or the like is used to extract the vector.

In the motion compensation using the optical flow, as illustrated in FIG. 6, the optical flow is acquired from the captured images of the VST cameras 23 that are external cameras. Then, the motion compensation is performed by deformation of the images in such a manner that the same subject overlaps.

As the deformation described herein, simple translation, nomography transformation, a method of acquiring an optical flow of an entire screen in units of pixels by using a local optical flow, and the like are considered.

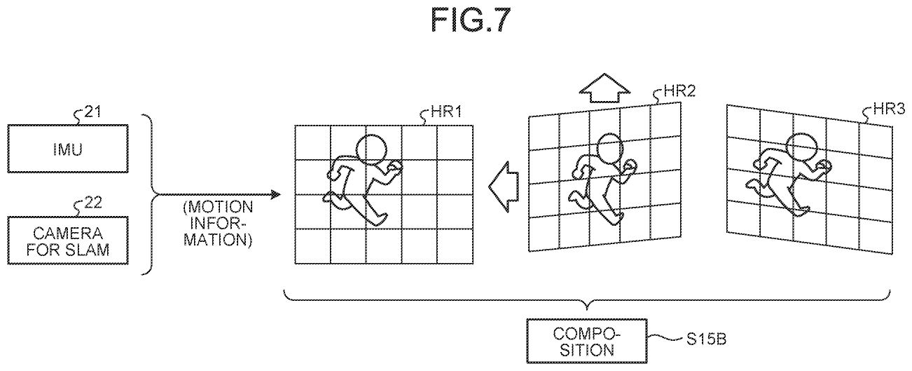

FIG. 7 is a view for describing the motion compensation using the self-position.

In a case where the motion compensation is performed by utilization of the self-position, a moving amount of the HMD unit 11 at timing at which a plurality of images is photographed is calculated by utilization of the captured images of the VST cameras 23, which captured images are camera images, or the IMU 21.

Then, the homography transformation according to the acquired moving amount of the HMD unit 11 is performed. Here, the homography transformation means to project a plane is onto another plane by using projection transformation.

Here, in a case where the homography transformation of a two-dimensional image is performed, since motion parallax varies depending on a distance between a subject and a camera, a depth of the target object is set as a representative distance. Here, the depth is acquired by eye tracking or screen averaging. In this case, a surface corresponding to the distance is referred to as a stabilization plane.

Then, motion compensation is performed by performing of the homography transformation in such a manner that motion parallax according to the representative distance is given.

Subsequently, the image composition unit 36 combines the one low-resolution image photographed at the total angle of view in the pixel addition mode and the plurality of high-resolution images photographed only in the region of interest at the full resolution (Step S15).

In this image composition, although described in detail below, processing of conversion into an HDR (Step S15A) and resolution enhancement processing (Step S15B) are performed.

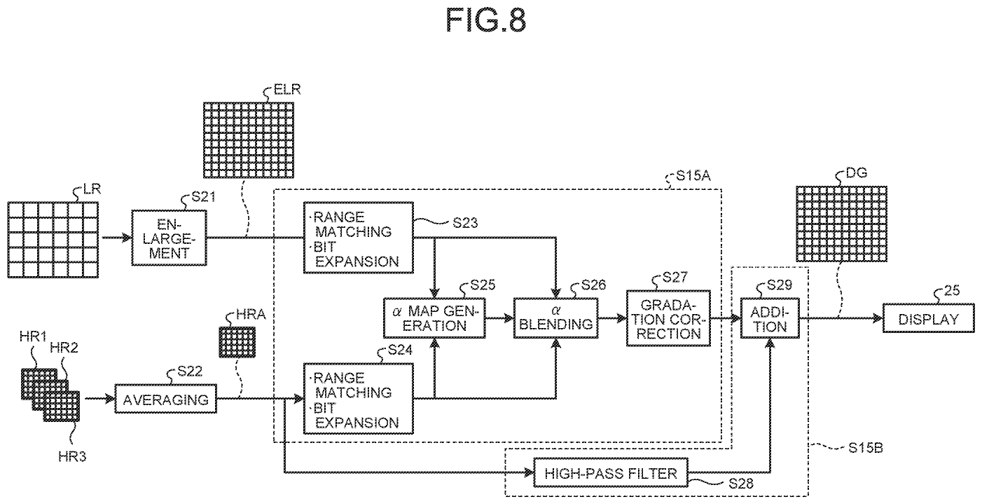

FIG. 8 is a view for describing the image composition.

When the image composition is performed, enlargement processing of the low-resolution image is performed in such a manner as to make the resolution match (Step S21).

Specifically, the low-resolution image LR is enlarged and an enlarged low-resolution image ELR is generated.

On the other hand, the high-resolution images HR1 to HR3 are aligned, and then one high-resolution image HRA is created by averaging of the plurality of images HR1 to HR3 (Step S22).

There are mainly two elements to be considered at the time of the image composition. The first is the processing of conversion into an HDR, and the second is the resolution enhancement processing.

As the processing of conversion into an HDR, processing of conversion into an HDR which processing uses exposure images with different exposure time will be briefly described here since being general processing in recent years.

As a basic idea of the processing of conversion into an HDR, images are combined in such a manner that a blending ratio of a long-exposure image (low-resolution image LR in the present embodiment) is high in a low luminance region in a screen, and images are combined in such a manner that a blending ratio of a short-exposure image (high-resolution image HRA in the present embodiment) is high in a high luminance region.

As a result, it is possible to generate an image that is as if photographed by a camera having a wide dynamic range, and to control an element that hinders a sense of immersion, such as a blown-out highlight and crushed shadow.

Hereinafter, the processing of conversion into an HDR S15A will be specifically described.

First, range matching and bit expansion are performed on the enlarged low-resolution image ELR and the high-resolution image HRA (Step S23 and S24). This is to make luminance ranges coincide with each other and to secure a band along with an expansion of a dynamic range.

Subsequently, an a map indicating a luminance distribution in units of pixels is generated for each of the enlarged low-resolution image ELR and the high-resolution image HRA (Step S25).

Then, on the basis of the luminance distribution corresponding to the generated a map, a blending of combining the enlarged low-resolution image ELR and the high-resolution image HRA is performed (Step S26).

More specifically, in the low luminance region, on the basis of the generated a map, the images are combined in units of pixels in such a manner that the blending ratio of the enlarged low-resolution image ELR that is the long-exposure image is higher than the blending ratio of the high-resolution image HRA that is the short-exposure image.

Similarly, in the high luminance region, on the basis of the generated a map, the images are combined in units of pixels in such a manner that the blending ratio of the high-resolution image HRA that is the short-exposure image is higher than the blending ratio of the enlarged low-resolution image ELR that is the long-exposure image.

Subsequently, since there is a portion where a gradation change is sharp in the combined image, gradation correction is performed in such a manner that the gradation change becomes natural, that is, the gradation change becomes gentle (Step S27).

In the above description, the processing of conversion into an HDR is effectively performed on both of the low-resolution image LR that is the first image and the high-resolution images HR1 to HR3 that are the second images. However, in generation of a composite image, the processing of conversion into an HDR may be performed on at least one of the low-resolution image LR that is the first image or the high-resolution images HR1 to HR3 that are the second images.

On the other hand, in the present embodiment, a resolution enhancement processing step S15B is performed by combination, according to a frequency region of the subject, of good points of the low-resolution image in which the exposure time is set to be long and the high-resolution images in which the exposure time is set to be short.

More specifically, the enlarged low-resolution image ELR is often used in a low-frequency region since being exposed for a long time and having a high SN ratio, and the high-resolution image HRA is often used in a high-frequency region since high-definition texture remains therein. Thus, frequency separation is performed with respect to the high-resolution image HRA by a high-pass filter (Step S28), and a high frequency component of the high-resolution image HRA from which the high frequency component is separated is added to an image after the α-blending (Step S29), whereby the resolution enhancement processing is performed. Then, resolution conversion processing is further performed and a display image DG is generated (Step S16), and the display image DG is output to the display 25 in real time (Step S17).

Here, outputting in real time means to perform an output in a manner of following the motion of the user in such a manner as to perform a display without causing the user to have feeling of strangeness.

As described above, according to the present embodiment, it is possible to control the motion blur due to the motion of the user and information of a transfer image data rate due to the resolution enhancement, and to make an effective dynamic range of the external cameras (VST camera 23 in the present embodiment comparable to a dynamic range in an actual visual field.

Here, photographing order of the low-resolution image and the high-resolution images, and an acquired effect will be described.

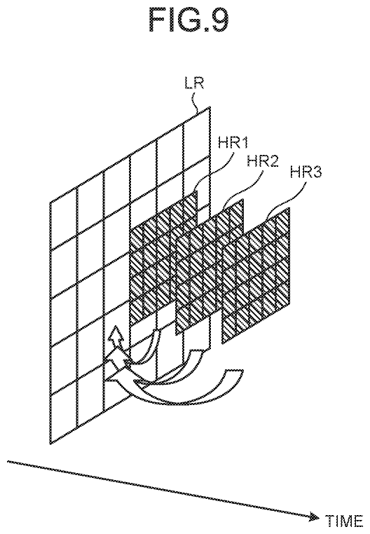

FIG. 9 is a view for describing the photographing order of the low-resolution image and the high-resolution images in the above embodiment.

In the above embodiment, the low-resolution image LR is photographed first, and then the three high-resolution images HR1 to HR3 are photographed.

Thus, the high-resolution images HR1 to HR3 to be combined are photographed after the low-resolution image LR that includes schematic contents of a photographing target and that is a basis of photographing timing at the time of the image composition such as the motion compensation.

As a result, exposure conditions of the high-resolution images HR1 to HR3 can be easily adjusted in accordance with an exposure condition of the low-resolution image LR, and a composite image with less strangeness can be acquired after the composition.

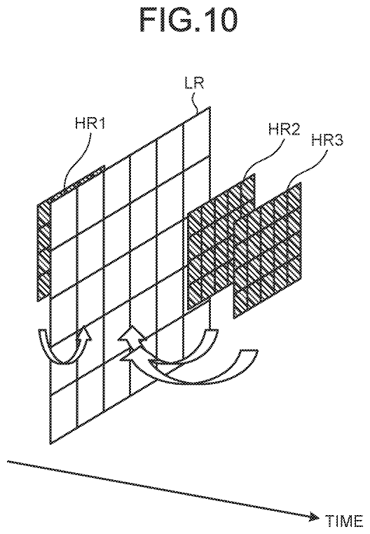

FIG. 10 is a view for describing another photographing order of a low-resolution image and high-resolution images.

Although the high-resolution images HR1 to HR3 are all photographed after the low-resolution image LR is photographed in the above embodiment, a low-resolution image LR is photographed after a high-resolution image HR1 is photographed, and then a high-resolution image HR2 and a high-resolution image HR3 are photographed in the example of FIG. 10.

As a result, a time difference between photographing timing of the high-resolution images HR1 to HR3 and photographing timing of the low-resolution image LR that is a basis of the image composition is reduced, and a temporal distance (and moving distance of the subject) of when the motion compensation is performed shortened, whereby it becomes possible to acquire a composite image with improved accuracy of the motion compensation.

In addition, a similar effect can be acquired when a low-resolution image LR is photographed after a high-resolution image HR1 and a high-resolution image HR2 are photographed, and a high-resolution image HR3 is then acquired instead of the above photographing order.

That is, even when the image sensor is controlled in such a manner that imaging of HR1 to HR3 that are the second images is performed before and after imaging of the low-resolution image LR that is the first image, a similar effect can be acquired.

More specifically, in a case where a plurality of high-resolution images is photographed, when a difference between the number of high-resolution images photographed before the photographing timing of the low-resolution image LR and the number of high-resolution images photographed after the photographing timing of the low-resolution image LR is made smaller (more preferably, the same number), a similar effect can be acquired.

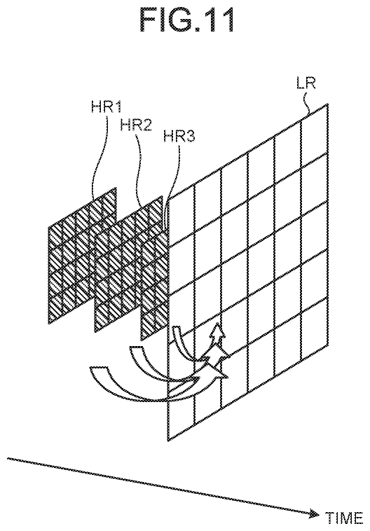

FIG. 11 is a view for describing another photographing order of a low-resolution image and high-resolution images.

In the above embodiment, the high-resolution images HR1 to HR3 are all photographed after the low-resolution image LR is photographed. However, in the example of FIG. 11, a low-resolution image LR is photographed after high-resolution images HR1 to HR3 are photographed, conversely.

As a result, it is possible to minimize latency (delay time) with respect to a motion of an actual subject of the low-resolution image LR that is the basis of the image composition, and nature in which a deviation between a display image by the composite image and a motion of the actual subject is the smallest can display the image.

### [6] Modification Example of the Embodiment

Note that an embodiment of the present technology is not limited to the above-described embodiment, and various modifications can be made within the spirit and the scope of the present disclosure.

In the above description, a configuration in which the three high-resolution images HR1 to HR3 are captured and combined with the one low-resolution image LR has been adopted. However, a similar effect can be acquired even when one or four or more low-resolution images are captured and combined with one low-resolution image LR.

Furthermore, the present technology can have the following configurations.

(1)

An image processing device comprising:

a control unit that generates a composite image and outputs the composite image to a display device, the composite image being acquired by combination of a first image captured in first exposure time and having first resolution, and a second image that is an image corresponding to a part of a region of the first image, and that is captured in second exposure time shorter than the first exposure time and has second resolution higher than the first resolution, the first image and the second image being input from an image sensor.

(2)

The image processing device according to (1), wherein

the control unit performs processing of conversion into an HDR on at least one of the first image or the second image when generating the composite image.

(3)

The image processing device according to (1) or (2), wherein

the control unit performs, on the second image, motion compensation based on imaging timing of the first image.

(4)

The image processing device according to any one of (1) to (3), wherein

the control unit receives input of a plurality of the second images corresponding to the one first image, and generates a composite image in which the first image and the plurality of second images are combined.

(5)

The image processing device according to any one of (1) to (4), wherein

the control unit controls the image sensor in such a manner that imaging of the first image is performed prior to imaging of the second image.

(6)

The image processing device according to any one of (1) to (4), wherein

the control unit controls the image sensor in such a manner that imaging of the second image is performed prior to imaging of the first image.

(7)

The image processing device according to (4), wherein

the control unit controls the image sensor in such a manner that imaging of the second image is performed both before and after imaging of the first image.

(8)

The image processing device according to (2), wherein

the control unit performs enlargement processing in such a manner that the resolution of the first image becomes the second resolution, and

generates the composite image after averaging a plurality of the second images.

(9)

The image processing device according to any one of (1) to (8), wherein

the region is a predetermined region of interest or a region of interest based on an eye gaze direction of a user.

(10)

The image processing device according to any one of (1) to (9), wherein

the control unit performs generation of the composite image and an output thereof to the display device in real time.

(11)

An image display system comprising:

an imaging device that includes an image sensor, and that outputs a first image captured in first exposure time and having first resolution and a second image that is an image corresponding to a part of a region of the first image, and that is captured in second exposure time shorter than the first exposure time and has second resolution higher than the first resolution;

an image processing device including a control unit that generates and outputs a composite image in which the first image and the second image are combined; and

a display device that displays the input composite image.

(12)

The image display system according to (11), wherein

the imaging device is mounted on a user,

the image display system includes an eye gaze direction detection device that detects an eye gaze direction of the user, and

the region is set on a basis of the eye gaze direction.

(13)

A method executed by an image processing device that controls an image sensor,

the method comprising the steps of:

inputting, from the image sensor, a first image captured in first exposure time and having first resolution, and a second image that is an image corresponding to a part of a region of the first image, and that is captured in second exposure time shorter than the first exposure time and has second resolution higher than the first resolution, the first image and the second image being input from the image sensor; and

generating a composite image in which the first image and the second image are combined.

(14)

A program for causing a computer to control an image processing device that performs control of an image sensor,

the program causing

the computer to function as

a unit to which a first image captured in first exposure time and having first resolution, and a second image that is an image corresponding to a part of a region of the first image, and that is captured in second exposure time shorter than the first exposure time and has second resolution higher than the first resolution are input from the image sensor, and

a unit that generates a composite image in which the first image and the second image are combined.

### REFERENCE SIGNS LIST

10 VR HEAD MOUNTED DISPLAY SYSTEM (IMAGE DISPLAY SYSTEM)
11 HEAD MOUNTED DISPLAY (HMD UNIT)
12 INFORMATION PROCESSING DEVICE (PC UNIT)
21 IMU
22 CAMERA FOR SLAM
23 VST CAMERA
23A IMAGE SENSOR
24 EYE TRACKING CAMERA
25 DISPLAY
31 SELF-LOCALIZATION UNIT
32 REGION-OF-INTEREST DETERMINATION UNIT
33 ISP
34 COMPENSATION UNIT
35 FRAME MEMORY
36 IMAGE COMPOSITION UNIT
AR REGION
ARF HIGHEST RESOLUTION REGION
CAR CENTRAL VISUAL FIELD REGION
DG DISPLAY IMAGE
ELR ENLARGED LOW-RESOLUTION IMAGE
HR1 to HR3, and HRA HIGH-RESOLUTION IMAGE
LDA LEFT EYE IMAGE
LR LOW-RESOLUTION IMAGE
PAR PERIPHERAL VISUAL FIELD REGION
RDA RIGHT EYE IMAGE
SAR EFFECTIVE VISUAL FIELD REGION

1. An image processing device comprising:
a control unit that generates a composite image and outputs the composite image to a display device, the composite image being acquired by combination of a first image captured in first exposure time and having first resolution, and a second image that is an image corresponding to a part of a region of the first image, and that is captured in second exposure time shorter than the first exposure time and has second resolution higher than the first resolution, the first image and the second image being input from an image sensor.

2. The image processing device according to claim 1, wherein
the control unit performs processing of conversion into an HDR on at least one of the first image or the second image when generating the composite image.

3. The image processing device according to claim 1, wherein
the control unit performs, on the second image, motion compensation based on imaging timing of the first image.

4. The image processing device according to claim 1, wherein
the control unit receives input of a plurality of the second images corresponding to the one first image, and generates a composite image in which the first image and the plurality of second images are combined.

5. The image processing device according to claim 1, wherein
the control unit controls the image sensor in such a manner that imaging of the first image is performed prior to imaging of the second image.

6. The image processing device according to claim 1, wherein
the control unit controls the image sensor in such a manner that imaging of the second image is performed prior to imaging of the first image.

7. The image processing device according to claim 4, wherein
the control unit controls the image sensor in such a manner that imaging of the second image is performed both before and after imaging of the first image.

8. The image processing device according to claim 2, wherein
the control unit performs enlargement processing in such a manner that the resolution of the first image becomes the second resolution, and
generates the composite image after averaging a plurality of the second images.

9. The image processing device according to claim 1, wherein
the region is a predetermined region of interest or a region of interest based on an eye gaze direction of a user.

10. The image processing device according to claim 1, wherein
the control unit performs generation of the composite image and an output thereof to the display device in real time.

11. An image display system comprising:
an imaging device that includes an image sensor, and that outputs a first image captured in first exposure time and having first resolution and a second image that is an image corresponding to a part of a region of the first image, and that is captured in second exposure time shorter than the first exposure time and has second resolution higher than the first resolution;
an image processing device including a control unit that generates and outputs a composite image in which the first image and the second image are combined; and
a display device that displays the input composite image.

12. The image display system according to claim 11, wherein
the imaging device is mounted on a user,
the image display system includes an eye gaze direction detection device that detects an eye gaze direction of the user, and
the region is set on a basis of the eye gaze direction.

13. A method executed by an image processing device that controls an image sensor,
the method comprising the steps of:
inputting, from the image sensor, a first image captured in first exposure time and having first resolution, and a second image that is an image corresponding to a part of a region of the first image, and that is captured in second exposure time shorter than the first exposure time and has second resolution higher than the first resolution, the first image and the second image being input from the image sensor; and
generating a composite image in which the first image and the second image are combined.

14. A program for causing a computer to control an image processing device that performs control of an image sensor,
the program causing
the computer to function as
a unit to which a first image captured in first exposure time and having first resolution, and a second image that is an image corresponding to a part of a region of the first image, and that is captured in second exposure time shorter than the first exposure time and has second resolution higher than the first resolution are input from the image sensor, and
a unit that generates a composite image in which the first image and the second image are combined.
